(19) United States
(12) Patent Application Publication
(10) Pub. No.: US 2021/0379916 A1
(43) Pub. Date: Dec. 9, 2021

(54) METHOD FOR PRODUCING LIGHT-ACCUMULATING TRANSFER SHEET, LIGHT-ACCUMULATING TRANSFER SHEET AND TRANSFER METHOD FOR LIGHT-ACCUMULATING TRANSFER SHEET FOR INKJET PRINTING

(71) Applicant: SANTOSHOJI CO., LTD., Osaka-shi, Osaka (JP)

(72) Inventor: Katsuo Sanari, Suita-shi, Osaka (JP)

(73) Assignee: SANTOSHOJI CO., LTD., Osaka-shi, Osaka (JP)

(21) Appl. No.: 16/325,611

(22) PCT Filed: May 25, 2018
(86) PCT No.: PCT/JP2018/020174

§ 371 Date: Feb. 14, 2019

(30) Foreign Application Priority Data
May 1, 2018 (JP) 2018-088437

(51) Int. Cl. B41M 5/00; B44C 1/17

(52) U.S. Cl. CPC B41M 5/0011; B44C 1/1725; B44C 1/1745; B44C 1/1737; B44C 1/1716

(57) ABSTRACT

A method for producing a light-accumulating transfer sheet, comprising an adhesive layer forming step for forming an adhesive layer on a supporting layer; a resin layer forming step for forming a resin layer on the adhesive layer; an infrared absorbing layer forming step for forming an infrared absorbing layer comprising an infrared absorbent on the resin layer; a microcapsule layer forming step for forming a microcapsule layer, in which microcapsules are dispersed, on the infrared absorption layer; and a pigment dispersion layer forming step for forming a pigment dispersion layer containing a light-accumulating pigment on the microcapsule layer, wherein the microcapsules comprise a heat-meltable content which is reversibly solidified and melted by heat from the infrared absorption layer and an encapsulant for encapsulating the heat-meltable content.

### TECHNICAL FIELD

The present invention relates to a method for producing a light-accumulating transfer sheet, a light-accumulating transfer sheet, and a transfer method for a light-accumulating transfer sheet for inkjet printing. More specifically, the present invention relates to a method for producing a light-accumulating transfer sheet that is able to emit high-luminance light for an extended period of time, a light-accumulating transfer sheet, and a transfer method for a light-accumulating transfer sheet for inkjet printing.

### BACKGROUND ART

Conventionally, transfer sheets containing a light-accumulating pigment have been invented for realizing visibility in a dark place (as in Patent Document 1). The transfer sheet described in Patent Document 1 comprises a substrate and a transfer layer that is peelable from the substrate and contains a hot-melt adhesive particle and a light-accumulating pigment.

### PRIOR ART DOCUMENT

Patent Document
Patent Document 1: JP 2003-312196 A

### SUMMARY OF THE INVENTION

However, in the transfer sheet described in Patent Document 1, emission of light by the light-accumulating pigment is insufficient in intensity and duration.

The present invention is made in consideration of such conventional problem, and the object is to provide a method for producing a light-accumulating transfer sheet that is able to emit high-luminance light for an extended period of time, a light-accumulating transfer sheet, and a transfer method for a light-accumulating transfer sheet for inkjet printing.

The method for producing a light-accumulating transfer sheet related to one embodiment of the present invention solving the above problem comprises an adhesive layer forming step for forming an adhesive layer on a supporting layer; a resin layer forming step for forming a resin layer on the adhesive layer; an infrared absorbing layer forming step for forming an infrared absorbing layer comprising an infrared absorbent on the resin layer; a microcapsule layer forming step for forming a microcapsule layer, in which microcapsules are dispersed, on the infrared absorption layer; and a pigment dispersion layer forming step for forming a pigment dispersion layer containing a light-accumulating pigment on the microcapsule layer, wherein the microcapsules comprise a heat-meltable content which is reversibly solidified and melted by heat from the infrared absorption layer and an encapsulant for encapsulating the heat-meltable content.

Also, the light-accumulating transfer sheet related to one embodiment of the present invention solving the above problem is a light-accumulating transfer sheet containing a light-accumulating pigment, comprising: a supporting layer; an adhesive layer formed on the supporting layer; a resin layer formed on the adhesive layer; an infrared absorption layer comprising an infrared absorbent formed on the resin layer; a microcapsule layer, in which microcapsules are dispersed, formed on the infrared absorption layer; and a pigment dispersion layer containing a light-accumulating pigment formed on the microcapsule layer, wherein the microcapsules comprise a heat-meltable content which is reversibly solidified and melted by heat from the infrared absorption layer and an encapsulant for encapsulating the heat-meltable content.

Also, the transfer method for the light-accumulating transfer sheet for inkjet printing related to one embodiment of the present invention solving the above problem is a transfer method for the light-accumulating transfer sheet containing a light-accumulating pigment, comprising an image forming step for forming an inkjet image on the protection layer of the light-accumulating transfer sheet by an inkjet recording method; a supporting layer peeling step for pushing an adhesive peelable film on the inkjet image to cover the inkjet image, and then peeling the supporting layer to expose the adhesive layer; and a transfer step for pressing the exposed adhesive layer on a transfer receiving object, and then transferring the inkjet image on the receiving object by peeling the adhesive peelable film.

### BRIEF DESCRIPTION OF THE DRAWINGS

FIG. 1 is a schematic side view of a supporting layer used in the method for producing a transfer sheet of one embodiment of the present invention.

FIG. 2 is a schematic side view of the supporting layer with an adhesive layer formed thereon in the method for producing a transfer sheet of one embodiment of the present invention.

FIG. 3 is a schematic side view of the adhesive layer with a resin layer formed thereon in the method for producing a transfer sheet of one embodiment of the present invention.

FIG. 4 is a schematic side view of the resin layer with an infrared absorption layer formed thereon in the method for producing a transfer sheet of one embodiment of the present invention.

FIG. 5 is a schematic side view of the infrared absorption layer with a microcapsule layer formed thereon in the method for producing a transfer sheet of one embodiment of the present invention.

FIG. 6 is a schematic side view of the microcapsule layer with a pigment dispersion layer formed thereon in the method for producing a transfer sheet of one embodiment of the present invention.

FIG. 7 is a schematic side view of the pigment dispersion layer of with an adhesive peelable film being applied thereto in the method for producing a transfer sheet of one embodiment of the present invention.

FIG. 8 is a schematic side view for illustrating the supporting layer being peeled in the method for producing a transfer sheet of one embodiment of the present invention.

FIG. 9 is a schematic side view of the pigment dispersion layer with a protection layer formed thereon in the method for producing a transfer sheet of one embodiment of the present invention (the first variation).

FIG. 10 is a schematic side view of the resin layer and the infrared absorption layer with a latent heat storage agent layer formed therebetween in the method for producing a transfer sheet of one embodiment of the present invention (the second variation).

### EMBODIMENT FOR CARRYING OUT THE INVENTION

<Method for Producing a Light-Accumulating Transfer Sheet>

A method for producing a light-accumulating transfer sheet of one embodiment of the present invention (hereinafter, also referred to as a method for producing a transfer sheet) is explained with reference to the figures. The method for producing a transfer sheet of the embodiment mainly comprises an adhesive layer forming step, a resin layer forming step, an infrared absorption layer forming step, a microcapsule layer forming step, and a pigment dispersion layer forming step. In the following, each of the steps is explained.

(Adhesive Layer Forming Step)

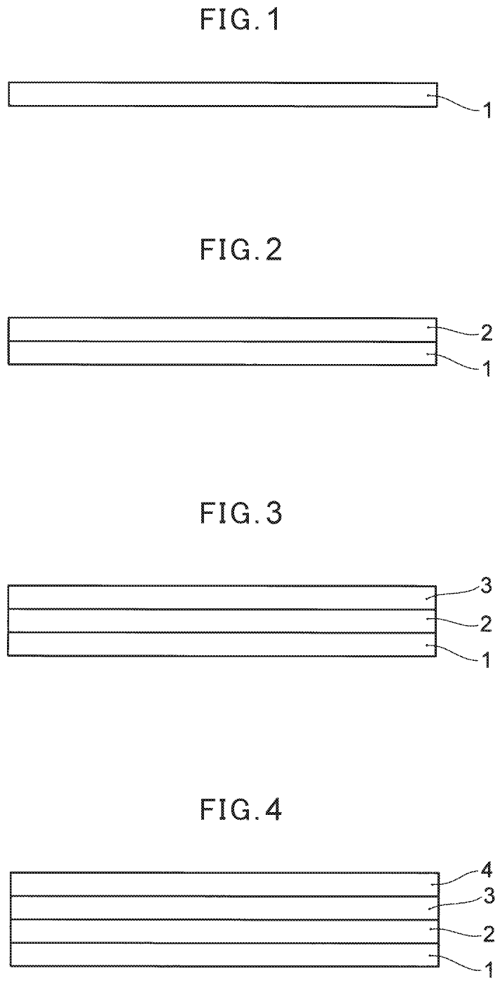

An adhesive layer forming step is a step for forming an adhesive layer on a supporting layer. FIG. 1 is a schematic side view of a supporting layer 1 used in the method for producing a transfer sheet of the embodiment. FIG. 2 is a schematic side view of the supporting layer 1 with an adhesive layer 2 formed thereon in the method for producing a transfer sheet of the embodiment.

Supporting Layer 1

The material of the supporting layer 1 is not particularly limited. Examples of the supporting layer 1 include resin sheets, papers, cloths, rubber sheets, foamed body sheets, metal foils, and the like. Examples of the resin sheets include polyolefin resin sheets such as polyethylene (PE), polypropylene (PP), and ethylene-propylene copolymer; polyester-based resin sheets such as polyethylene terephthalate (PET), polybutylene terephthalate (PBT), and polyethylene naphthalate (PEN); vinyl chloride resin sheets; vinyl acetate resin sheets; polyimide resin sheets; polyamide resin sheets; fluoric resin sheets; cellophanes, and the like. Examples of the papers include Japanese papers, craft papers, glassines, woodfree uncoated papers, synthetic papers, top coated papers, and the like. Examples of the cloths include woven fabrics and nonwoven fabrics made by spinning one or mixed fibrous materials. Examples of the rubber sheets include natural rubber sheets, and butyl rubber sheets, and the like. Examples of the foamed body sheets include foamed polyolefin sheets such as foamed PE sheet, foamed polyester sheet, foamed polyurethane sheet, foamed polychloroprene rubber sheet, and the like. Examples of the metal foils include aluminum foil, copper foil, and the like. Among those, the supporting layer 1 is preferably polyethylene terephthalate (PET) for the reasons of physical characteristics (such as dimensional stability, thickness precision, workability, and tensile strength), economical efficiency (cost), and the like.

The thickness of the supporting layer 1 is not particularly limited. For example, the thickness of the supporting layer 1 is about 25-100 μm.

Adhesive Layer 2

The adhesive layer 2 is made of a resin having adhesiveness. In the embodiment, the adhesive layer 2 may be a resin having adhesiveness at normal temperature or a hot-melt resin having adhesiveness when heated.

Examples of the resin having adhesiveness at normal temperature include acrylic resins, urethane resins, silicone resins, and the like. Examples of the hot-melt resin include urethane resins, polyamide resins, olefin resins, polyester resins, and the like.

Examples of the urethane resins include thermoplastic urethane resins, which are obtained by reaction between a diisocyanate component and a diol component, and the like. Examples of the diisocyanate component include aromatic diisocyanate, aliphatic-aromatic diisocyanate, alicyclic diisocyanate, aliphatic diisocyanate, and the like. Examples of the diol component include low-molecular-weight diols such as aliphatic diol, alicyclic diol, and aromatic diol as well as polyether diol, polyester diol, polycarbonate diol, and the like. Examples of the urethane resins include urethane resins such as polyester-type urethane resin, polycarbonate-type urethane resin, and polyether-type urethane resin; polyurethane urea resin, and the like.

Examples of the polyamide resins include polyamide 6, polyamide 46, polyamide 66, polyamide 610, polyamide 612, polyamide 11, polyamide 12, polyamide resins produced by reaction between a dimer acid and a diamine, polyamide elastomers, and the like.

Examples of the olefin resins include a homopolymer or a copolymer of α-olefins (particularly, α-C2-10 olefin) such as ethylene, propylene, 1-butene, 3-methyl-1-pentene, 4-methyl-1-butene, 1-hexene, and 1-octene; olefin elastomers; and the like.

Examples of the polyester resins include homopolyester resins or copolyester resins with at least aliphatic diol or aliphatic dicarboxylic acid; polyester elastomers; and the like.

The softening point of the hot-melt resin is about 70-180° C. Also, the melting point of the hot-melt resin is about 50-250° C.

When fabric such as clothes is used as a transfer receiving object, the hot-melt resin is, among those described above, preferably an urethane resin, an olefin resin, and the like, in view of adhesiveness such as interlayer adhesion, softness, and texture.

The thickness of the adhesive layer 2 is not particularly limited. For example, the thickness of the adhesive layer 2 is about 20-100 μm. For example, when pushed against a transfer receiving object, the adhesive layer 2 having such thickness is less likely to extend beyond the edge. Also, such adhesive layer 2 is likely to provide weather resistance to the resulting transfer sheet.

The method for forming the adhesive layer 2 on the supporting layer 1 is not particularly limited. For example, the adhesive layer 2 can be formed on the supporting layer 1 by means of general-purpose printing methods such as a heliogravure method and a screen-printing method, a roll coater method, or the like.

(Resin Layer Forming Step)

The resin layer forming step is a step for forming a resin layer on the adhesive layer 2. FIG. 3 is a schematic side view of the adhesive layer 2 with a resin layer 3 formed thereon in the method for producing a transfer sheet of the embodiment.

Resin Layer 3

The resin constituting the resin layer 3 is not particularly limited. Examples of the resin constituting the resin layer 3 include acrylic resins, cellulosic resins, polyester resins, vinyl resins, polyurethane resins, polycarbonate resins, or partly crosslinking resins of those, and the like. Among those, the resin layer 3 is preferably made of polyester for its excellent softness and handling property.

The thickness of the resin layer 3 is not particularly limited. For example, the thickness of the resin layer 3 is about 10-40 μm. When a transfer sheet with the resin layer 3 having such thickness is transferred to a transfer receiving object, the color of the transfer receiving object is likely to be hidden; therefore, the image, such as an inkjet image, transferred by the transfer sheet is likely to be expressed clearly.

Also, the degree of light transmittance of the resin layer 3 is not particularly limited. For example, pigment is dispersed in the resin layer 3 to lower the light transmittance. Examples of such pigment include white pigments and the like.

Examples of the white pigments include titanium oxide, zinc oxide, as well as inorganic fillers such as silica, alumina, clay, talc, calcium carbonate or barium sulfate; and resin particles (plastic pigments) of acryl resins, epoxy resins, polyurethane resins, phenol resins, melamine resins, benzoguanamine resins, fluororesins, or silicone resins. When the resin layer 3 contains a pigment (for example, a white pigment), the method for producing a transfer sheet of the embodiment can form a clearer image in a process of forming an inkjet image as will be described below.

When pigment is dispersed in the resin layer 3, the mixing ratio between the resin and the pigment is, for example, about 1:1 to 1:10.

The method for forming the resin layer 3 is not particularly limited. For example, the resin layer 3 can be formed on the adhesive layer 2 by means of general-purpose printing methods such as a heliogravure method and a screen-printing method, a roll coater method, or the like.

(Infrared Absorption Layer Forming Step)

The infrared absorption layer forming step is a step for forming an infrared absorption layer 4 comprising an infrared absorbent on the resin layer 3. FIG. 4 is a schematic side view of the resin layer 3 with the infrared absorption layer 4 formed thereon in the method for producing a transfer sheet of the embodiment.

Infrared Absorption Layer 4

The infrared absorption layer 4 is a layer containing an infrared absorbent and formed on the resin layer 3. The infrared absorbent is not particularly limited. Examples of the infrared absorbent include carbon black, copper oxide, manganese dioxide, active carbon, nonmagnetic ferrite, black pigments such as magnetite, other various inorganic materials, and organic pigments. The inorganic materials are preferably metal oxides, more preferably antimony tin oxide (ATO) and indium tin oxide (ITO). The organic pigments are cyanine pigment, phthalocyanine pigment, merocyanine dyes, squarylium pigment, onium compound, indolenine cyanine, pyrylium salt, nickel thiolate complex, or others, and preferably cyanine pigment, phthalocyanine pigment, merocyanine pigment, squarylium pigment, or others. Among those, carbon black is preferable as the infrared absorbent because it is low-cost, easy to handle, and excellent in infrared absorption. It should be noted that in the embodiments the infrared light refers to the wavelength range between 700 nm and 1 mm.

When the infrared absorption is carbon black, the size of the carbon black is not particularly limited. For example, the size of the carbon black (the particle size) is preferably 0.1 μm or larger, more preferably 1 μm or larger. Also, the particle size of the carbon black is preferably 15 μm or smaller, more preferably 10 μm or smaller. When the particle size of the carbon black is in the above range, the carbon black tends to be dispersed uniformly in the infrared absorption layer 4.

The infrared absorbent is dispersed or dissolved in resin for forming a layer on the resin layer 3. The resin in which the infrared absorbent is dispersed or dissolved is not particularly limited. Examples of such resin include polyester resins, acrylic resins, polyamide resins, polyurethane resins, polyolefin resins, and polycarbonate resins. Among those resins, acrylic resins are preferable for their excellent transparency, heat resistance, and solvent resistance.

The content of the infrared absorbent in the infrared absorption layer 4 is not particularly limited. For example, the infrared absorbent is preferably 10% by mass or more of the resin, more preferably 15% by mass or more. Also, the infrared absorbent is preferably 30% by mass or less of the resin, more preferably 25% by mass or less. When the content of the infrared absorbent is below 15% by mass, there is a tendency that a light-accumulating pigment as will be described later cannot be heated sufficiently. On the other hand, the content of the infrared absorbent is above 30% by mass, the light-accumulating pigment tends to be overheated.

Also, the infrared absorbent may be suitably dispersed in an organic solvent instead of the above resins. Examples of such organic solvent include alcohols such as methanol, ethanol, n-propyl alcohol, isopropyl alcohol, n-butylalcohol, tridecyl alcohol, cyclohexanol, and 2-methylcyclohexanol; glycols such as ethylene glycol, diethylene glycol, triethylene glycol, polyethylene glycol, propylene glycol, and dipropylene glycol, and glycerin; glycol ethers such as ethylene glycol monomethyl ether, ethylene glycol monoethylene ether, ethylene glycol monobutyl ether, diethylene glycol monomethyl ether, diethylene glycol monoethyl ether, diethylene glycol butyl ether, ethylene glycol monomethyl ether acetate, ethylene glycol monoethyl acetate, diethylene glycol monobutyl acetate, diethylene glycol monomethyl acetate, diethylene glycol monoethyl acetate, diethylene glycol monobutyl acetate; esters such as ethyl acetate, Isopropyl acetate, and n-Butyl acetate; ketones such as acetone, ethyl methyl ketone, methyl isobutyl ketone, cyclohexanone, cyclopentanone, isophorone, and diacetone alcohol.

The thickness of the infrared absorption layer 4 is not particularly limited. For example, the thickness of the infrared absorption layer 4 is about 10-30 μm. The infrared absorption layer 4 having such thickness is likely to be suitably heated by exposure to sunlight or the like.

The method for forming the infrared absorption layer 4 is not particularly limited. For example, the infrared absorption layer 4 can be formed on the resin layer 3 by means of general-purpose printing methods such as a heliogravure method and a screen-printing method, a roll coater method, or the like.

In the embodiment, when the infrared absorption layer 4 is exposed to sunlight for about 30 minutes, for example, at a surrounding temperature of 20° C., heat is generated by an effect of photothermal conversion, and the temperature of the infrared absorption layer 4 becomes about 2-20° C. higher than the surroundings. Also, in such situation, heat generation of the infrared absorption layer 4 continues for about 5 to 30 minutes. By such heat and the heat retaining effect of the microcapsule layer 5 as will be described later, a light-accumulating pigment 61 in a pigment dispersion layer 6 as will be described below is heated for an extended period of time and thus continuously emit light excellently. It should be noted that as the infrared absorption layer 4 is continuously exposed to sunlight or the like, it can remain in a heated state. Also, a light source to which the infrared absorption layer 4 is exposed is not limited to sunlight and may be a fluorescent lamp, an LED light source, a black light, or the like.

(Microcapsule Layer Forming Step)

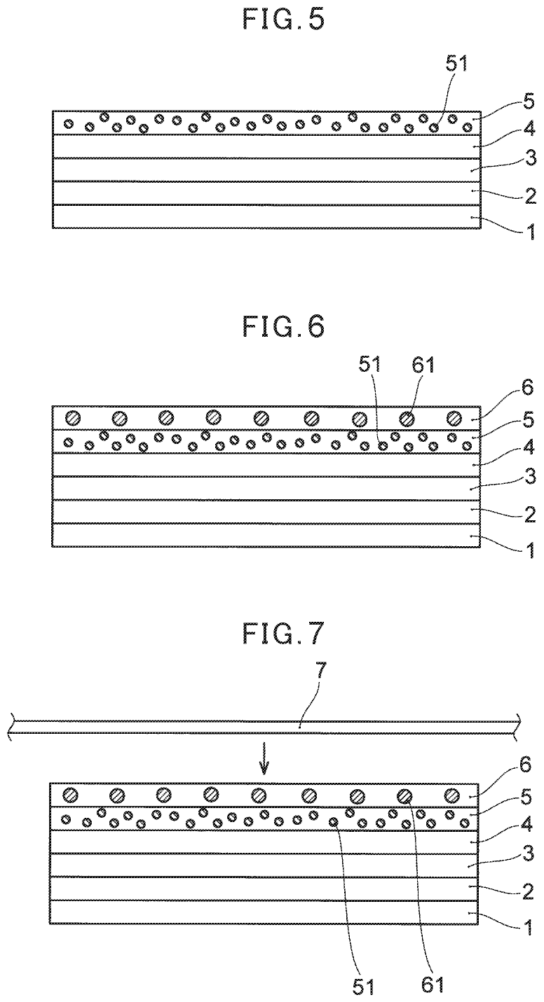

The microcapsule layer forming step is a step for forming a microcapsule layer in which microcapsules are dispersed on the infrared absorption layer 4. FIG. 5 is a schematic side view of the infrared absorption layer 4 with a microcapsule layer 5 formed thereon in the method for producing a transfer sheet of the embodiment.

Microcapsule Layer 5

The microcapsule layer 5 is a layer in which microcapsules 51 are dispersed and formed on the infrared absorption layer 4. The microcapsules 51 comprise a heat-meltable content which is reversibly solidified and melted by heat from the infrared absorption layer 4 and an encapsulant for encapsulating the heat-meltable content.

The heat-meltable content is solid to semisolid at normal temperature and has a property of being melted by heat from the infrared absorption layer 4. The heat-meltable content is not particularly limited. Examples of the heat-meltable content includes a liquid paraffin, n-paraffins comprising n-octadecane or n-hexadecane as the main component, inorganic hydrated salts (such as calcium chloride hexahydrate and sodium sulfate decahydrate), fatty acids (such as palmitic acid and myristic acid), aromatic hydrocarbon compounds (such as benzene and p-xylene), ester compounds (such as isopropyl palmitate and butyl stearate), alcohols (such as stearyl alcohol), polyalkylene glycol, and the like. Among those, a liquid paraffin is preferable for the heat-meltable content because it is low-cost and easily available.

The heat-meltable content is melted by the above-mentioned heat from the infrared absorption layer 4. The heat-meltable content in such melted state retains the received heat for a long period of time and keeps heating a light-accumulating pigment 61 in pigment dispersion layer 6, as will be described later, causing it illuminating in high brightness.

The encapsulant is supposed to have properties such that it is able to encapsulate the heat-meltable content and it is not melted by heat from the infrared absorption layer 4. Examples of the encapsulant include polyurethane, polyamide, melamine resin, urea resin, alginate, polyacrylic resin, gelatin, gum arabic, and others. Among those, melamine resin and polyurethane resin are preferable as the encapsulant because they are excellent in heat resistance and solvent resistance.

The size of the microcapsules 51 is preferably 2 μm or more, more preferably 5 μm or more. Also, the size of the microcapsules is preferably 15 μm or less, more preferably 10 μm or less. When the size of the microcapsules 51 is less than 5 μm, the heat that the microcapsules may retain tends to be too small. On the other hand, when the size of the microcapsules 51 is more than 10 μm, the surface quality of the microcapsule layer 5 tends not to be uniform.

The microcapsules 51 are dispersed or dissolved in resin for forming a layer on the infrared absorption layer 4. The resin in which the microcapsules 51 are dispersed or dissolved is not particularly limited. Examples of such resin include polyester resins, acrylic resins, polyamide resins, polyurethane resins, polyolefin resins, and polycarbonate resins. Among those, acrylic resins are preferable because they are excellent in transparency, heat resistance, and solvent resistance.

The content of the microcapsules 51 in the microcapsule layer 5 is not particularly limited. For example, the microcapsules 51 is preferably 5% by mass or more in the resin, more preferably 10% by mass or more. Also, the microcapsules 51 is preferably 50% by mass or less in the resin, more preferably 45% by mass or less. When the content of the microcapsules 51 is less than 5% by mass, the light-accumulating pigment is less likely to be heated sufficiently. On the other hand, when the content of the microcapsules 51 is more than 50% by mass, the light-accumulating pigment tends to be overheated.

The thickness of the microcapsule layer 5 is not particularly limited. For example, the thickness of the microcapsule layer 5 is about 20-40 μm. The microcapsule layer 5 having such thickness is excellent in retaining the heat transmitted from the infrared absorption layer 4 and transmitting the retained heat to the pigment dispersion layer 6.

The method for forming the microcapsule layer 5 is not particularly limited. For example, the microcapsule layer 5 can be formed on the infrared absorption layer 4 by applying the melted resin containing the microcapsules 51 onto the infrared absorption layer 4 by means of a general-purpose printing method such as a heliogravure method, a screen-printing method, a roll coater method, or the like.

(Pigment Dispersion Layer Forming Step)

The pigment dispersion layer forming step is a step for forming a pigment dispersion layer 6 comprising a light accumulating pigment 61 on the microcapsule layer 5. FIG. 6 is a schematic side view of the microcapsule layer 5 with the pigment dispersion layer 6 formed thereon in the method for producing a transfer sheet of the embodiment.

Light-Accumulating Pigment 61

The light-accumulating pigment 61 is a pigment which absorbs light energy, keep it temporarily, and then gradually radiate the energy in the form of phosphorescence. The light-accumulating pigment 61 is not particularly limited. Examples of the light-accumulating pigment 61 include sulfide fluorescent substances such as potassium sulfide, zinc sulfide, and zinc sulfide cadmium; and an aluminate fluorescent substance comprising strontium, europium, and dysprosium. Regarding the aluminate fluorescent, in the compounds represented by MAl₂O₄, the M comprises a compound comprising at least one metallic element selected from a group consisting of calcium, strontium, barium as a matrix crystal and suitably comprises an augmenting agent such as europium, cerium, praseodymium, neodymium, samarium, terbium, dysprosium, holmium, erbium, thulium, ytterbium, and lutetium.

In the embodiment, the light-accumulating pigment 61 preferably contains strontium, more preferably contains strontium aluminate as the main component with an augmenting agent such as europium and dysprosium added thereto because they are able to emit high-luminance light for an extended period of time. Such light-accumulating pigment 61 is specifically exemplified by SrAl₂O₄:Eu, Dy; Sr₄Al₁₄O₂₅:Eu, Dy; and the like.

Also, the light-accumulating pigment 61 may be coated by amorphous silica on the surface as the light-accumulating pigment described in, for example, JP 5729698 B. It should be noted that the light-accumulating pigment described in JP 5729698 B is one example of the light-accumulating pigment used most preferably in the embodiment.

The mean particle size of the light-accumulating pigment 61 is preferably not less than 10 μm, more preferably not less than 20 μm. Also, the mean particle size of the light-accumulating pigment 61 is preferably not more than 100 μm. When the light-accumulating pigment 61 has a mean particle size of less than 10 μm, it is not likely to emit sufficient light. On the other hand, when the light-accumulating pigment 61 has a mean particle size of more than 100 μm, it is likely to have a degraded handling property. It should be noted that the mean particle size of the light-accumulating pigment 61 is a 50% mean particle size (D50) which can be calculated based on the measurement using, for example, SLD-3100 (manufactured by Shimadzu Corporation).

Also, the intensity of the light emitted by the light-accumulating pigment 61 depends on the temperature. Specifically, the light-accumulating pigment 61 emits more intense light at a higher temperature (e.g., about 200° C.). However, when the transfer receiving object is clothes or the like, heating it to such high temperature is not appropriate. As described above, for example, when exposed to sunlight for about 30 minutes in a condition at the temperature of 20-23° C., the infrared absorbent in the infrared absorption layer 4 generates heat. Also, the heat by the infrared absorption layer 4 is transferred to the above microcapsule layer 5 and melts a heat-meltable content in the microcapsules 51. The heat-meltable content in the melted state retains the given heat for a long period of time. Therefore, the infrared absorption layer 4 and the microcapsule layer 5 keeps heating the light-accumulating pigment 61 so that it continuously emits suitable light. Also, the pigment dispersion layer 6 keeps emitting light by being exposed to other light sources (such as a fluorescent light) than sunlight. Thus, as the light-accumulating pigment 61 is continuously heated, it can emit light with high luminance for an extended period of time. In the method for producing a transfer sheet of the embodiment, the light-accumulating pigment 61 in the pigment dispersion layer 6 is heated by the above-mentioned infrared absorption layer 4 and the microcapsule layer 5; therefore, it can emit more intense and longer light compared to conventional techniques where the infrared absorption layer and the microcapsule layer is not formed.

The light-accumulating pigment 61 is dispersed of dissolved in resin for forming a layer on the microcapsule layer 5. The resin in which the light-accumulating pigment 61 is dispersed and dissolved is not particularly limited. Examples of such resin include polyester resins, acrylic resins, polyamide resins, polyurethane resins, epoxy resins, polyolefin resins, polycarbonate resins, and the like. Among those, the resin is preferably a polyester resin, an epoxy resin, or a polycarbonate resin because they are highly transparent.

The content of the light-accumulating pigment 61 in the pigment dispersion layer 6 is not particularly limited. For example, the light-accumulating pigment 61 is preferably 10% by mass in the resin or more. Also, the light-accumulating pigment 61 is preferably 50% by mass in the resin or less. When the content of the light-accumulating pigment 61 is less than 10% by mass, it is less likely to emit sufficient light. On the other hand, when the content of the light-accumulating pigment 61 is more than 50% by mass, the light-accumulating pigment 61 becomes less likely to be dissolved in the resin.

The thickness of the pigment dispersion layer 6 is not particularly limited. For example, the thickness of the pigment dispersion layer 6 is about 50-200 μm. The pigment dispersion layer 6 having such thickness has an advantage that the heat added by the infrared absorption layer 4 and the microcapsule layer 5 is easily and sufficiently transferred, and thus the light-accumulating pigment 61 easily emits light.

According to the method for producing a light-accumulating transfer sheet including the above steps, a light-accumulating transfer sheet is produced, wherein the light-accumulating transfer sheet comprises the supporting layer 1; the adhesive layer 2 formed on the supporting layer 1; the resin layer 3 formed on the adhesive layer 2; the infrared absorption layer 4 formed on the resin layer 3 and containing the infrared absorbent; the microcapsule layer 5, in which the microcapsules 51 are dispersed, formed on the infrared absorption layer 4; the pigment dispersion layer 6 containing the light-accumulating pigment 61 and formed on the microcapsule layer 5. According to the above method for producing a light-accumulating transfer sheet and the light-accumulating transfer sheet to be obtained, the infrared absorption layer 4 generates heat by an effect of photothermal conversion of the infrared absorbent. With this heat, the heat-meltable content of the microcapsules 51 of the microcapsule layer 5 is melted in the microcapsules 51, with the heat retained therein, and, in turn, it heats the light-accumulating pigment 61 in the pigment dispersion layer. Consequently, the light-accumulating pigment 61 is likely to emit light with high luminance. Also, by the heat generated by the infrared absorption layer 4 and the heat retained in the heat-meltable content in the melted state, the light-accumulating pigment 61 is likely to remain in a heated state. Consequently, the light-accumulating pigment 61 is likely to continuously emit light for an extended period of time. In addition, the heat-meltable content melts within the microcapsules 51 and does not leak outside the capsules. The heat-meltable content is thus less likely to be lost and contaminate the surroundings. As a result, the light-accumulating transfer sheet to be obtained can be used repeatedly for an extended period of time, resistant to aging degradation and performance degradation.

More specifically a pigment dispersion layer 6 containing, for example, the light-accumulating pigment descried in JP 5729698 B is provided as the light-accumulating pigment 61 of the present embodiment to cover 90% of the microcapsule layer 5 having a thickness of 30 μm (containing 30% by mass of the microcapsules 51 comprising a liquid paraffin (melting point: 30° C.) as the heat-meltable content and encapsulant (size: 5 μm) made of melamine, polyester) seen from a top view, so that the thickness when dried is 100 μm. In addition, when this microcapsule layer 5, with a sheet formed on the infrared absorption layer 4 (thickness: 20 μm) containing 20% by mass of carbon black as an infrared absorbent, is exposed to sunlight for 20 minutes, it can emit bright light in 111 (mcd/m²) 10 minutes after the process of exposure, in 53 (mcd/m²) 20 minutes after the process, in 34 (mcd/m²) 30 minutes after the process, in 25 (mcd/m²) 40 minutes after the process, in 20 (mcd/m²) 50 minutes after the process, in 16 (mcd/m²) or higher 60 minutes after the process, that exceeds the standard of JIS JB class (30 (mcd/m²) 30 minutes after the process and 15 (mcd/m²) 60 minutes after the process). It should be noted that when the microcapsule layer 5 was not provided, the emitted light 60 minutes after the process was 15 (mcd/m²) or lower.

Additionally, when the thickness of the pigment dispersion layer 6 was changed to 200 μm, the emitted light was 209 (mcd/m²) 10 minutes after the process, 109 (mcd/m²) 20 minutes after the process, 72 (mcd/m²) 30 minutes after the process, 53 (mcd/m²) 40 minutes after the process, 42 (mcd/m²) 50 minutes after the process, 34 (mcd/m²) 60 minutes after the process, that exceeds by far the standard of JIS JC class (62 (mcd/m²) 30 minutes after the process and 30 (mcd/m²) 60 minutes after the process). It should be noted that when the microcapsule layer 5 was not provided, the emitted light 60 minutes after the process was 30 (mcd/m²) or lower.

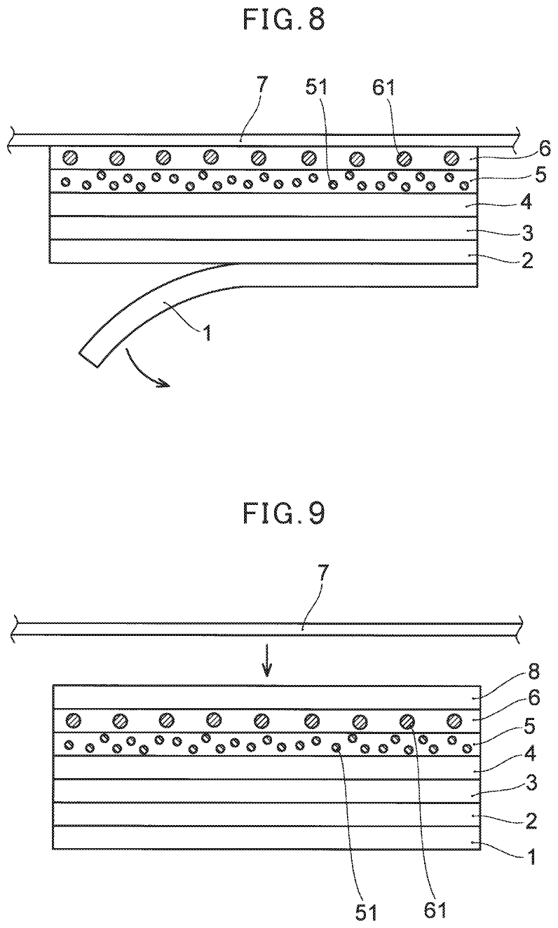

In the light-accumulating transfer sheet obtained by the method for producing a light-accumulating transfer sheet, an adhesive peelable film (a tack film) is pushed against the sheet, and it is peeled together with the supporting layer 1 so that the adhesive layer 2 can be exposed. FIG. 7 is a schematic side view of an adhesive peelable film 7 being applied to the pigment dispersion layer 6 of the transfer sheet in the method for producing a transfer sheet of the embodiment transfer sheet. FIG. 8 is a schematic side view for illustrating the supporting layer 1 being peeled in the method for producing a transfer sheet of the embodiment.

In the transfer sheet obtained by the method for producing a transfer sheet of the embodiment, the adhesive layer 2, which has been exposed by peeling the supporting layer 1, is pressed (or heat transfer printed) against a transfer receiving object, and then the adhesive peelable film 7 is peeled so that transfer printing is made on the transfer receiving object.

The transfer receiving object is not particularly limited. Examples of the transfer receiving object include a two-dimensional or three-dimensional structure made of any of various materials such as fibers, papers, woods, plastics, ceramics, and metals.

### Variation (the First Variation) of the Present Embodiment

In the method for producing a transfer sheet of the above embodiment, as shown in FIG. 7, an example where the adhesive peelable film 7 is pressed against the pigment dispersion layer 6 is shown. Alternatively, a method for producing a transfer sheet of the present embodiment (the first variation) can further comprise a protection layer forming step.

(Protection Layer Forming Step)

The protection layer forming step is a step for forming a protection layer 8 on the pigment dispersion layer 6. It should be noted that a protection layer 8 is provided mainly for the purpose of providing weather resistance to the transfer sheet. Also, the protection layer 8 serves as an ink receiving layer when an inkjet image is formed thereon. FIG. 9 is a schematic side view of the pigment dispersion layer 6 with the protection layer 8 formed thereon in the method for producing a transfer sheet of the embodiment. The protection layer 8 is not particularly limited. For example, the protection layer 8 may be a so-called resin-based ink receiving layer, which consists mainly of a hydrophilic binder or may be a pigment-based ink receiving layer, which has gaps made by the pigment in the recording layer.

The resin-based receiving layer is formed by applying and then drying a solution of a water soluble resin such as a polyvinyl alcohol, a polyvinyl pyrrolidone, a water-soluble cellulose derivative, and a gelatin. The resin-based receiving layer is highly transparent and glossy.

The thickness of the protection layer 8 is not particularly limited. For example, the thickness of the protection layer 8 is about 50-150 μm. The protection layer 8 having such thickness is excellent in weather resistance and allows easy image formation thereon.

On the protection layer 8, an inkjet image is formed by the method for inkjet recording as described below. Also, the protection layer 8 with an inkjet image formed thereon can transfer the inkjet image on a transfer receiving object by pushing the adhesive peelable film 7 (a retack film) against the protection layer 8, peeling the supporting layer 1 to expose the adhesive layer 2, and then pressing (or heat transfer printing) the adhesive layer 2 against the transfer receiving object, as mentioned above. The light-accumulating pigment 61 in the transferred inkjet image can effectively emit light and provides excellent visibility even in a dark place. Therefore, the transfer sheet obtained in the embodiment can be suitably applied to uses aimed for decorative effect especially in a dark place, equipment related to traffic safety for calling for drivers' and pedestrians' attention, and equipment used in factories, construction sites, and the like. Also, such transfer sheet can be used for emphasizing a display medium when transferred in accordance with the shapes of letters, symbols, figures, and the like. In addition, the transfer sheet can transfer a leading sign to a corridor, stairs, and the like. Moreover, when the transfer sheet is transferred to a cover of lighting equipment or a light source, it can be applied as a kind of emergency light.

### Variation (the Second Variation) of the Present Embodiment

In the method for producing a transfer sheet the above embodiment, an example where the infrared absorption layer 4 is formed on the resin layer 3 is shown, as shown in FIG. 7. Alternatively, the method for producing a transfer sheet of the present embodiment (the second variation) may further comprise a latent heat storage agent layer forming step.

(Latent Heat Storage Agent Layer Forming Step)

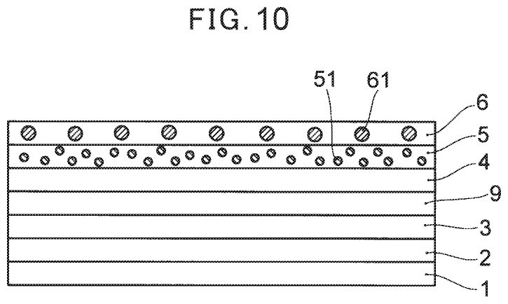

The latent heat storage agent forming step is a step for forming a latent heat storage agent layer 9 comprising a latent heat storage agent on the resin layer 3. FIG. 10 is a schematic side view of the resin layer and the infrared absorption layer with a latent heat storage agent layer formed therebetween in the method for producing a transfer sheet of the embodiment.

Latent Heat Storage Agent Layer 9

The latent heat storage agent layer 9 is a layer comprising latent heat storage agent. The latent heat storage agent is not particularly limited. Examples of the latent heat storage agent include n-paraffins comprising n-octadecane or n-hexadecane as the main component, inorganic hydrated salts (such as calcium chloride hexahydrate and sodium sulfate decahydrate), fatty acids (such as palmitic acid and myristic acid), aromatic hydrocarbon compounds (such as benzine and p-xylene), ester compounds (such as isopropyl palmitate and butyl stearate), alcohols (such as stearyl alcohol), polyalkylene glycol, and the like. Among those, the latent heat storage agent is preferably a paraffin because it is low in price and easily available.

The latent heat storage agent is dispersed of dissolved in resin for forming a layer on the resin layer 3. The resin in which the latent heat storage agent is dispersed and dissolved is not particularly limited. Examples of such resin include polyester resins, acrylic resins, polyamide resins, polyurethane resins, epoxy resins, polyolefin resins, polycarbonate resins, and the like. Among those, the resin is preferably a polyester resin, an epoxy resin, or a polycarbonate resin because they are highly transparent.

The thickness of the latent heat storage agent layer 9 is not particularly limited. For example, the thickness of the latent heat storage agent layer 9 is about 10-50 μm. The latent heat storage agent layer 9 having such thickness is able to suitably store heat and likely to increase the intensity of light emitted by the light-accumulating pigment 61.

When the latent heat storage agent is dispersed in the resin, the mixing ratio between the resin and the latent heat storage agent is, for example, about 3:10 to 5:10.

The method for forming the latent heat storage agent layer 9 is not particularly limited. For example, the latent heat storage agent layer 9 can be formed on the resin layer 3 by means of general-purpose printing methods such as a heliogravure method and a screen-printing method, a roll coater method, or the like.

According to the transfer sheet provided with the latent heat storage agent layer 9, the light-accumulating pigment 61 is suitably heated. Consequently, the light-accumulating pigment 61 is likely to emit light with high luminance. Also, the light-accumulating pigment 61 is likely to remain in a heated state by the heat generated by the infrared absorption layer 4 and the heat retaining effect of the microcapsule layer 5. Consequently, the light-accumulating pigment 61 is likely to continuously emit light for an extended period of time.

### Variation (the Third Variation) of the Present Embodiment

In the method for producing a transfer sheet of the above embodiment (the second variation), an example where the latent heat storage agent layer 9 is formed on the resin layer 3, as shown in FIG. 10. Alternatively, in a method for producing a transfer sheet of the present embodiment (the third variation), the latent heat storage agent can be mixed in the resin layer 3. Thus the light-accumulating pigment 61 is heated by the latent heat storage agent in the resin layer 3 via the infrared absorption layer 4 formed on the resin layer 3. Consequently, the light-accumulating pigment 61 is likely to emit light with high luminance. Also, the light-accumulating pigment 61 is likely to remain in a heated state by the heat generated by the infrared absorption layer 4 and the heat retaining effect of the microcapsule layer 5. Consequently, the light-accumulating pigment 61 is likely to continuously emit light for an extended period of time.

When the latent heat storage agent is mixed in the resin layer 3, the mixing amount is not particularly limited. For example, relative to 100 parts by mass of the resin, 30-50 parts by mass of the latent heat storage agent is mixed.

### Variation (the Forth Variation) of the Present Embodiment

In the method for producing a transfer sheet of the above embodiment (the second variation), an example where the latent heat storage agent layer 9 is formed on the resin layer 3, as shown in FIG. 10. Alternatively, in a method for producing a transfer sheet of the present embodiment (the forth variation), the latent heat storage agent layer 9 can be formed between the infrared absorption layer 4 and the microcapsule layer 5. Thus the light-accumulating pigment 61 is heated by the latent heat storage agent in the latent heat storage agent layer 9 via the infrared absorption layer 4 and the microcapsule layer 5. Consequently, the light-accumulating pigment 61 is likely to emit light with high luminance. Also, the light-accumulating pigment 61 is likely to remain in a heated state by the heat generated by the infrared absorption layer 4 and the heat retaining effect of the microcapsule layer 5. Consequently, the light-accumulating pigment 61 is likely to continuously emit light for an extended period of time.

<Transfer Method for the Light-Accumulating Transfer Sheet>

A transfer method for the light-accumulating transfer sheet of one embodiment of the present invention (which is also referred to as a transfer method, hereinafter) is a method in which the protection layer 8 and an inkjet image are formed on the light-accumulating transfer sheet manufactured in the above embodiment and subsequently the transfer sheet is transferred on a transfer receiving object. Specifically, the transfer method for the present embodiment mainly comprises an image forming step, a supporting layer peeling step, and a transfer step.

(Image Forming Step)

The image forming step is a step for forming an inkjet image by an inkjet recording method on the protection layer 8 of the light-accumulating transfer sheet as described above. The conditions for the inkjet recording method (printing conditions) are not particularly limited. The printing conditions such as a nozzle diameter of an inkjet printer, an applied voltage, a pulse width, a drive frequency, a resolution, an amount of ink to be supplied are suitably selected for forming a desired inkjet image on the protection layer 8.

(Supporting Layer Peeling Step)

The supporting layer peeling step is a step for pushing the adhesive peelable film 7 (a retack film) on an inkjet image to cover the inkjet image, and then peeling the supporting layer 1 to expose the adhesive layer 2. Specifically, in this step, the adhesive peelable film 7 is pushed against an inkjet image.

(Transfer Step)

The transfer step is a step for pressing the exposed adhesive layer 2 on a transfer receiving object, and then transferring the inkjet image on the receiving object by peeling the adhesive peelable film 7. The transfer receiving object is not particularly limited. For example, the transfer receiving object is a two-dimensional or three-dimensional structure made of any of various materials such as fibers, papers, woods, plastics, ceramics, and metals.

According to the transfer method for the present embodiment, the light-accumulating pigment 61 in an inkjet image to be transferred effectively emits light and provides excellent visibility even in a dark place for an extended period of time. Therefore, the transfer method of the present embodiment can be suitably applied to uses aimed for decorative effect especially in a dark place, equipment related to traffic safety for calling for drivers' and pedestrians' attention, and equipment used in factories, construction sites, and the like. Moreover, according to the transfer method, an emphasizing effect of a display medium can be obtained when transferring is performed in accordance with the shapes of letters, symbols, figures, and the like. In addition, the transfer method allows a transfer sheet to be transferred to a corridor, stairs, and the like as a leading sign. Furthermore, the transfer method allows a transfer sheet to be applied as a kind of emergency light by transferring the transfer sheet to a cover of lighting equipment or a light source.

So far, one embodiment of the present invention has been explained. The present invention is not limited to the above embodiment. It should be noted that the above embodiment is one embodiment of the invention having the following configuration.

(1) A method for producing a light-accumulating transfer sheet, comprising: an adhesive layer forming step for forming an adhesive layer on a supporting layer; a resin layer forming step for forming a resin layer on the adhesive layer; an infrared absorbing layer forming step for forming an infrared absorbing layer comprising an infrared absorbent on the resin layer; a microcapsule layer forming step for forming a microcapsule layer, in which microcapsules are dispersed, on the infrared absorption layer; and a pigment dispersion layer forming step for forming a pigment dispersion layer containing a light-accumulating pigment on the microcapsule layer, wherein the microcapsules comprise a heat-meltable content which is reversibly solidified and melted by heat from the infrared absorption layer and an encapsulant for encapsulating the heat-meltable content.

According to this configuration, the infrared absorption layer generates heat by an effect of photothermal conversion of the infrared absorbent. With this heat, the heat-meltable content of the microcapsules of the microcapsule layer is melted in the microcapsules, with the heat retained therein, and, in turn, it heats the light-accumulating pigment in the pigment dispersion layer. Consequently, the light-accumulating pigment is likely to emit light with high luminance. Also, by the heat generated by the infrared absorption layer and the heat retained in the heat-meltable content in the melted state, the light-accumulating pigment is likely to remain in a heated state. Consequently, the light-accumulating pigment is likely to continuously emit light for an extended period of time. In addition, the heat-meltable content melts within the microcapsules and does not leak outside the capsules. The heat-meltable content is thus less likely to be lost and contaminate the surroundings. As a result, the light-accumulating transfer sheet to be obtained can be used repeatedly for an extended period of time, resistant to aging degradation and performance degradation.

(2) The method for producing a light-accumulating transfer sheet of (1), comprising a protection layer forming step for forming a protection layer on the pigment dispersion layer.

According to this configuration, when an inkjet image is formed on, for example, the protection layer, the inkjet image formed thereon emits a bright light with high luminance for an extended period of time.

(3) The method for producing a light-accumulating transfer sheet of (1) or (2), wherein the infrared absorbent is a carbon black.

According to this configuration, the infrared absorbent is low-cost, easy to handle, and excellent in infrared absorption. Consequently, the light-accumulating pigment is likely to emit a brighter light for a long period of time.

(4) The method for producing a light-accumulating transfer sheet of any of (1) to (3), wherein the heat-meltable content is a liquid paraffin.

According to this configuration, the heat-meltable content is likely to melt by heat and retain the heat. Consequently, the light-accumulating pigment is likely to emit a light for a longer time.

(5) The method for producing a light-accumulating transfer sheet of any of (1) to (4), wherein the infrared absorption layer forming step is a step for, after forming a latent heat storage agent layer containing a latent heat storage agent, forming an infrared absorption layer containing the infrared absorbent on the resin layer.

According to this configuration, the light-accumulating transfer sheet to be obtained is provided with the latent heat storage agent layer between the resin layer and the infrared absorption layer. This latent heat storage agent layer can heat the heat-meltable content and the light-accumulating pigment of the microcapsules. Therefore, the light-accumulating pigment is likely to emit a brighter light. Moreover, the light-accumulating pigment is likely to remain in a heated state for a longer time. Consequently, the light-accumulating pigment tends to keep emitting a light for a longer time.

(6) The method for producing a light-accumulating transfer sheet of any one of (1) to (4), wherein the microcapsule layer forming step is a step for, after forming a latent heat storage agent layer containing a latent heat storage agent, forming a microcapsule layer in which the microcapsules are dispersed on the infrared absorption layer.

According to this configuration, the light-accumulating transfer sheet to be obtained is provided with the latent heat storage agent layer between the infrared absorption layer and the microcapsule layer. This latent heat storage agent layer can heat the heat-meltable content and the light-accumulating pigment of the microcapsules. Therefore, the light-accumulating pigment is likely to emit a brighter light. Moreover, the light-accumulating pigment is likely to remain in a heated state for a longer time. Consequently, the light-accumulating pigment tends to keep emitting a light for a longer time.

(7) A light-accumulating transfer sheet containing a light-accumulating pigment, comprising: a supporting layer; an adhesive layer formed on the supporting layer; a resin layer formed on the adhesive layer; an infrared absorption layer comprising an infrared absorbent formed on the resin layer; a microcapsule layer, in which microcapsules are dispersed, formed on the infrared absorption layer; and a pigment dispersion layer containing a light-accumulating pigment formed on the microcapsule layer, wherein the microcapsules comprise a heat-meltable content which is reversibly solidified and melted by heat from the infrared absorption layer and an encapsulant for encapsulating the heat-meltable content.

According to this configuration, the infrared absorption layer generates heat by an effect of photothermal conversion of the infrared absorbent. With this heat, the heat-meltable content of the microcapsules of the microcapsule layer is melted in the microcapsules, with the heat retained therein, and, in turn, it heats the light-accumulating pigment in the pigment dispersion layer. Consequently, the light-accumulating pigment is likely to emit light with high luminance. Also, by the heat generated by the infrared absorption layer and the heat retained in the heat-meltable content in the melted state, the light-accumulating pigment is likely to remain in a heated state. Consequently, the light-accumulating pigment is likely to continuously emit light for an extended period of time. In addition, the heat-meltable content melts within the microcapsules and does not leak outside the capsules. The heat-meltable content is thus less likely to be lost and contaminate the surroundings. As a result, the light-accumulating transfer sheet to be obtained can be used repeatedly for an extended period of time, resistant to aging degradation and performance degradation.

(8) The light-accumulating transfer sheet of (7), wherein a protection layer is formed on the pigment dispersion layer.

According to this configuration, when an inkjet image is formed on, for example, the protection layer, the inkjet image formed thereon emits a bright light with high luminance for an extended period of time.

(9) The method for producing a light-accumulating transfer sheet of (7) or (8), wherein the infrared absorbent is a carbon black.

According to this configuration, the infrared absorbent is low-cost, easy to handle, and excellent in infrared absorption. Consequently, the light-accumulating pigment is likely to emit a brighter light for a long period of time.

(10) The method for producing a light-accumulating transfer sheet of any one of (7) to (9), wherein the heat-meltable content is a liquid paraffin.

According to this configuration, the heat-meltable content is likely to melt by heat and retain the heat. Consequently, the light-accumulating pigment is likely to emit a light for a longer time.

(11) The method for producing a light-accumulating transfer sheet of any one of (7) to (10), wherein a latent heat storage agent layer containing a latent heat storage agent is formed between the resin layer and the infrared absorption layer.

According to this configuration, the light-accumulating transfer sheet is provided with the latent heat storage agent layer between the resin layer and the infrared absorption layer. This latent heat storage agent layer can heat the heat-meltable content and the light-accumulating pigment of the microcapsules. Therefore, the light-accumulating pigment is likely to emit a brighter light. Moreover, the light-accumulating pigment is likely to remain in a heated state for a longer time. Consequently, the light-accumulating pigment tends to keep emitting a light for a longer time.

(12) The method for producing a light-accumulating transfer sheet of any one of (7) to (10), wherein a latent heat storage agent layer containing a latent heat storage agent is formed between the infrared absorption layer and the microcapsule layer.

According to this configuration, the light-accumulating transfer sheet is provided with the latent heat storage agent layer between the infrared absorption layer and the microcapsule layer. This latent heat storage agent layer can heat the heat-meltable content and the light-accumulating pigment of the microcapsules. Therefore, the light-accumulating pigment is likely to emit a brighter light. Moreover, the light-accumulating pigment is likely to remain in a heated state for a longer time. Consequently, the light-accumulating pigment tends to keep emitting a light for a longer time.

(13) A transfer method for the light-accumulating transfer sheet containing a light-accumulating pigment, comprising: an image forming step for forming an inkjet image on the protection layer of the light-accumulating transfer sheet of (8) by an inkjet recording method; a supporting layer peeling step for pushing an adhesive peelable film on the inkjet image to cover the inkjet image, and then peeling the supporting layer to expose the adhesive layer; and a transfer step for pressing the exposed adhesive layer on a transfer receiving object, and then transferring the inkjet image on the receiving object by peeling the adhesive peelable film.

According to this configuration, the light-accumulating pigment in an inkjet image to be transferred effectively emits light and provides excellent visibility even in a dark place for an extended period of time. Therefore, the transfer method of the present invention can be suitably applied to uses aimed for decorative effect especially in a dark place, equipment related to traffic safety for calling for drivers' and pedestrians' attention, and equipment used in factories, construction sites, and the like. Moreover, according to the transfer method, an emphasizing effect of a display medium can be obtained when transferring is performed in accordance with the shapes of letters, symbols, figures, and the like. In addition, the transfer method allows a transfer sheet to be transferred to a corridor, stairs, and the like as a leading sign. Furthermore, the transfer method allows a transfer sheet to be applied as a kind of emergency light by transferring the transfer sheet to a cover of lighting equipment or a light source.

### REFERENCE SIGN LIST

1 supporting layer
2 adhesive layer
3 resin layer
4 infrared absorption layer
5 microcapsule layer
51 microcapsules
6 pigment dispersion layer
61 light-accumulating pigment
7 adhesive peelable film
8 protection layer
9 latent heat storage agent layer

The claims defining the invention are as follows:

1. A method for producing a light-accumulating transfer sheet, comprising:
an adhesive layer forming step for forming an adhesive layer on a supporting layer;
a resin layer forming step for forming a resin layer on the adhesive layer;
an infrared absorbing layer forming step for forming an infrared absorbing layer comprising an infrared absorbent on the resin layer;
a microcapsule layer forming step for forming a microcapsule layer, in which microcapsules are dispersed, on the infrared absorption layer; and
a pigment dispersion layer forming step for forming a pigment dispersion layer containing a light-accumulating pigment on the microcapsule layer,
wherein the microcapsules comprise a heat-meltable content which is reversibly solidified and melted by heat from the infrared absorption layer and an encapsulant for encapsulating the heat-meltable content.

2. The method for producing a light-accumulating transfer of claim 1, comprising a protection layer forming step for forming a protection layer on the pigment dispersion layer.

3. The method for producing a light-accumulating transfer sheet of claim 1, wherein the infrared absorbent is a carbon black.

4. The method for producing a light-accumulating transfer sheet of claim 1, wherein the heat-meltable content is a liquid paraffin.

5. The method for producing a light-accumulating transfer sheet of claim 1, wherein the infrared absorption layer forming step is a step for, after forming a latent heat storage agent layer containing a latent heat storage agent, forming an infrared absorption layer containing the infrared absorbent on the resin layer.

6. The method for producing a light-accumulating transfer sheet of claim 1, wherein the microcapsule layer forming step is a step for, after forming a latent heat storage agent layer containing a latent heat storage agent, forming a microcapsule layer in which the microcapsules are dispersed on the infrared absorption layer.

7. A light-accumulating transfer sheet containing a light-accumulating pigment, comprising:
a supporting layer;
an adhesive layer formed on the supporting layer;
a resin layer formed on the adhesive layer;
an infrared absorption layer comprising an infrared absorbent formed on the resin layer;
a microcapsule layer, in which microcapsules are dispersed, formed on the infrared absorption layer; and
a pigment dispersion layer containing a light-accumulating pigment formed on the microcapsule layer,
wherein the microcapsules comprise a heat-meltable content which is reversibly solidified and melted by heat from the infrared absorption layer and an encapsulant for encapsulating the heat-meltable content.

8. The light-accumulating transfer sheet of claim 7, wherein a protection layer is formed on the pigment dispersion layer.

9. The method for producing a light-accumulating transfer sheet of claim 7, wherein the infrared absorbent is a carbon black.

10. The method for producing a light-accumulating transfer sheet of claim 7, wherein the heat-meltable content is a liquid paraffin.

11. The method for producing a light-accumulating transfer sheet of claim 7, wherein a latent heat storage agent layer containing a latent heat storage agent is formed between the resin layer and the infrared absorption layer.

12. The method for producing a light-accumulating transfer sheet of claim 7, wherein a latent heat storage agent layer containing a latent heat storage agent is formed between the infrared absorption layer and the microcapsule layer.

13. A transfer method for the light-accumulating transfer sheet containing a light-accumulating pigment, comprising:
an image forming step for forming an inkjet image on the protection layer of the light-accumulating transfer sheet of claim 8 by an inkjet recording method;
a supporting layer peeling step for pushing an adhesive peelable film on the inkjet image to cover the inkjet image, and then peeling the supporting layer to expose the adhesive layer; and
a transfer step for pressing the exposed adhesive layer on a transfer receiving object, and then transferring the inkjet image on the receiving object by peeling the adhesive peelable film.
